(19) United States
(12) Patent Application Publication
(10) Pub. No.: US 2024/0370894 A1
(43) Pub. Date: Nov. 7, 2024

(54) CONTEXTUALLY AWARE PROMOTED CONTENT IN INTERACTIVE SOFTWARE APPLICATION

(71) Applicant: Microsoft Technology Licensing, LLC, Redmond, WA (US)

(72) Inventors: Jared E. HENDERSON, Maple Valley, WA (US); Daniel G. KENNETT, Redmond, WA (US); Morgan Asher BROWN, Redmond, WA (US); Shawn FARKAS, Kirkland, WA (US); Joseph WHEELER, Sammamish, WA (US); Stylianos TSINAROGLOU, Bothell, WA (US); Yi-An CHIEN, Redmond, WA (US)

(21) Appl. No.: 18/141,905

(22) Filed: May 1, 2023

(51) Int. Cl. G06Q 30/0217; G06F 9/451; G06F 9/54

(52) U.S. Cl. CPC G06Q 30/0217; G06F 9/451; G06F 9/542

(57) ABSTRACT

A content management system may obtain a promoted content trigger event from an interactive software application based at least partially on content of the interactive software application. A content management system may suspend a user's interaction with the interactive software application based on the promoted content trigger event. A content management system may obtain promoted audiovisual content. A content management system may present the promoted audiovisual content to the user. A content management system may commence the user's interaction with the interactive software application. A content management system may establish a credit based at least partially on the promoted audiovisual content, wherein the credit delays suspension of the user's interaction with the interactive software application during a credit duration.

### BACKGROUND

Streaming audiovisual content can be supported by promoted audiovisual content through periodic breaks in the streaming audiovisual content. In non-interactive audiovisual content such periodic breaks can be placed at a variety of predictable times in the content without adversely affecting the user experience. However, interactive software applications which stream interactive audiovisual content can provide a more varied user experience and predicting when to suspend interaction and present promoted audiovisual content can be challenging.

### BRIEF SUMMARY

In some aspects, the techniques described herein relate to a method of providing content to a user, the method including: obtaining a promoted content trigger event from an interactive software application based at least partially on content of the interactive software application; suspending a user's interaction with the interactive software application based on the promoted content trigger event; obtaining promoted audiovisual content; presenting the promoted audiovisual content to the user; commencing the user's interaction with the interactive software application; and establishing a credit based at least partially on the promoted audiovisual content, wherein the credit delays suspension of the user's interaction with the interactive software application during a credit duration.

In some aspects, the techniques described herein relate to a method of providing content to a user, the method including: establishing a first credit with a first credit duration; determining a window based on the first credit duration; commencing a user's interaction with an interactive software application; during the window: obtaining a promoted content trigger event from the interactive software application based at least partially on content of the interactive software application; suspending the user's interaction with the interactive software application; and presenting promoted audiovisual content to the user.

In some aspects, the techniques described herein relate to a system including: a client device including: a processor, and a hardware storage device in data communication with the processor, wherein the hardware storage device has instructions stored thereon that, when executed by the processor, cause the client device to: obtain a promoted content trigger event from an interactive software application based at least partially on content of the interactive software application; suspend a user's interaction with the interactive software application based on the promoted content trigger event; obtain promoted audiovisual content; present the promoted audiovisual content to a user; commence the user's interaction with the interactive software application; and establish a credit based at least partially on the promoted audiovisual content, wherein the credit delays suspension of the user's interaction with the interactive software application during a credit duration.

This Summary is provided to introduce a selection of concepts in a simplified form that are further described below in the Detailed Description. This Summary is not intended to identify key features or essential features of the claimed subject matter. Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic illustration of a system for presenting content to a user during an interactive software application, according to at least some embodiments of the present disclosure.

FIG. 2 is a timeline of promoted content presentation and interactive software application usage, according to at least some embodiments of the present disclosure.

FIG. 3 is a flowchart illustrating a method of providing promoted content to a user, according to at least some embodiments of the present disclosure.

FIG. 4 is a timeline of promoted content presentation and interactive software application usage using API hints, according to at least some embodiments of the present disclosure.

FIG. 5 is a system diagram of a system for providing content to a user using API hints, according to at least some embodiments of the present disclosure.

FIG. 6 is a timeline illustrating providing promoted information to a user by a user-initiated promoted content trigger event, according to at least some embodiments of the present disclosure.

FIG. 7 is a system diagram of a system for providing content to a user-initiated promoted content trigger event, according to at least some embodiments of the present disclosure.

FIG. 8 is a timeline illustrating providing promoted information to a user using event hints, according to at least some embodiments of the present disclosure.

FIG. 9 is a schematic representation of a machine learning (ML) model, according to at least some embodiments of the present disclosure.

FIG. 10 is an embodiment of a frame of video information received from the interactive software application that may be used for identifying events within the user's gameplay, according to at least some embodiments of the present disclosure.

FIG. 11 is a timeline illustrating providing promoted information to a user by a user-confirmed promoted content trigger event, according to at least some embodiments of the present disclosure.

FIG. 12 is a flowchart illustrating another method of presenting content to a user, according to at least some embodiments of the present disclosure.

### DETAILED DESCRIPTION

The present disclosure relates generally to the presentation of promoted content, such announcements, alerts, and other audiovisual information to inform users of events or information. More particularly, the present disclosure relates to context-aware presentation of promoted audiovisual information or promoted audiovisual content to a user during use of an interactive software application. In some embodiments, the context for the promoted audiovisual information is provided by a transmission, call, timing, flag, or other hint from the interactive software application, such as via an application programming interface (API) signal. In some embodiments, the context is provided by a user interacting with the interactive software application. In some embodiments, the context is provided by an event detection model, system, or module that detects objects, animations, textures, images, characters, sounds, or inputs to or from the interactive software application.

Promoted audiovisual information may be presented to a user to allow the user to earn credits for the use of the interactive software application. The presentation of the promoted audiovisual information includes interrupting and/or suspending the user's interaction with the interactive software application. During the presentation of the promoted audiovisual information, the interactive software application may be paused, suspended, or constrained at the operating system level to prevent interaction with the interactive software application by the user and to prevent events occurring in the interactive software application while the user is presented the promoted audiovisual information. In a particular example, the interactive software application is a video game, and the gameplay of the video game is paused to prevent adverse occurrences. In at least one example, the video game is a driving racing game, and the game is paused, suspended, or constrained to prevent the user's car from crashing while the promoted audiovisual information is presented to the user.

In some examples, user inputs to the interactive software application are paused, suspended, interrupted, or otherwise prevented while the software application remains active. For example, the promoted audiovisual information may be presented to the user when the context of the interactive software application indicates adverse occurrences are unlikely or not possible to occur. For example, the promoted audiovisual information may be presented to the user when an avatar of the user in a virtual environment of the interactive software application is determined to be in a safe location, such as the user's team base.

In some embodiments, the credit delays the suspension of interaction with the interactive software application and/or presentation of further promoted audiovisual information and associated interruptions of the user's interaction with the interactive software application for a period of time. For example, the credit may have a credit duration of a nominal time, such as 15 minutes, 30 minutes, 1 hour, or longer. In some embodiments, the credit delays the suspension of interaction with the interactive software application presentation of further promoted audiovisual information and associated interruptions of the user's interaction with the interactive software application for a predetermined progression or interaction with the interactive software application. For example, the credit may have a credit duration defined at least partially by progression or events in the interactive software application, such as 5 rounds of gameplay, completing one level of a video game, completing 3 online multiplayer matches, defeating a particular non-playable character (NPC), or completing a project or task within the interactive software application. In some embodiments, systems and methods according to the present disclosure allow a user to earn or be assigned more than one credit at a time or through a variety of activities.

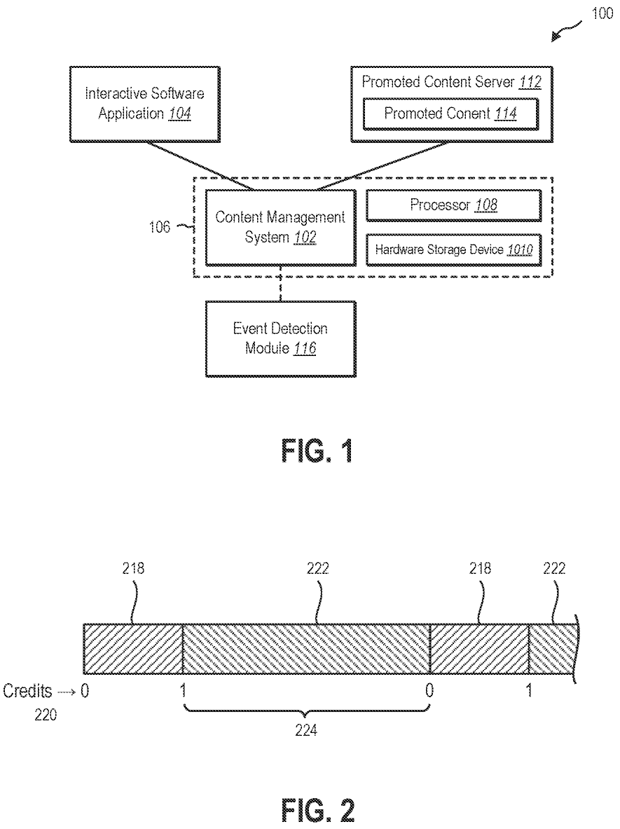

FIG. 1 is a system diagram of a system 100 for providing content to a user. The system 100 includes a content management system 102 that is in data communication with an interactive software application 104. In some embodiments, the content management system 102 is local to a client device 106. In some examples, the client device 106 is or includes a laptop computer, a desktop computer, a video game console, a set top box, a smart television, a smartphone, a table computer, a hybrid computer, a head-mounted display, or any other electronic device capable of presenting audiovisual information to a user.

In some embodiments, the interactive software application 104 is stored on and/or executed locally on the client device 106. For example, the client device 106 may include a processor 108 and hardware storage device 110 that includes instructions stored thereon that, when executed by the processor, cause the client device 106 to run the interactive software application 104. The processor 108, in some embodiments, is a central processing unit (CPU) that performs general computing tasks for the client device 106. In some embodiments, the processor(s) 108 is or is part of a system on chip (SoC) that is dedicated to controlling or communicating with one or more subsystems of the client device 106. The hardware storage device 110 is a non-transient storage device including any of RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

In some embodiments, the client device 106 further includes additional components, such as a user input device; a display; special purpose processors, such as a graphics processor; a communication device; and other components. In some embodiments, the input device(s) is a mouse, a stylus, a trackpad, a touch-sensitive device, a touch-sensitive display, a keyboard, or other input human-interface device.

In some embodiments, the input device(s) is part of the client device 106, such as a trackpad or a keyboard. In some embodiments, the input device(s) is a discrete device in data communication with the computing device, such as a gamepad in wireless data communication with the client device 106.

In some embodiments, the display(s) is a liquid crystal display (LCD), a light emitting diode (LED) display, a thin film transistor (TFT) display, a cathode ray tube (CRT) display, or other display. In some embodiments, the display is integrated into the client device 106. In some embodiments, the display is a discrete monitor or other display that is in wired or wireless data communication with the client device 106.

In some embodiments, the graphics processor(s) is discrete from the CPU or other processor 108 and is in data communication with the CPU or other processor 108. In some embodiments, the graphics processor(s) is integrated with (e.g., on a shared die with) another processor 108. In some embodiments, a communication device(s) is in data communication with the processor(s) 108 to allow communication with one or more external computing devices, networks, or components.

In some embodiments, the communication device is a network communications device, such as including a wired (e.g., Ethernet) port or wireless (e.g., WiFi) antenna. In some embodiments, the communication device is a short-range wireless communication, such as a BLUETOOTH connection or a WiFi-Direct connection, that allows data communication between the client device 106 and electronic devices in proximity to the client device 106. In some embodiments, the communication device is a near-field communications (NFC) device that is used for data communication, wireless charging of other components and/or accessory devices, or both.

In some embodiments, the interactive software application 104 is stored on and/or executed remotely from the client device 106, such as on a remote server or remote computing device in which the client device is in network communication. For example, the interactive software application 104 may be stored on and executed on a streaming server that streams the audiovisual information to the client device 106. Audiovisual information is provided to the client device 106 for presentation to the user, such as via a display, audio speakers, haptic devices, etc. In some embodiments, user inputs are transmitted from the client device 106 to the interactive software application 104.

While FIG. 1 illustrates the content management system 102 local to the client device 106, it should be understood that the content management system 102 may be remote to the client device 106, such as described in relation to the remote server of the interactive software application 104. The content management system 102 may be stored and/or executed remotely to the client device 106 on the same server computer as the interactive software application 104 or may be stored and/or executed remotely to the interactive software application 104 such as on a different server computer.

In some embodiments, the content management system 102 manages the presentation of promoted audiovisual information (“promoted content” 114) obtained from a promoted content server 112 that is remote from the client device 106 and/or content management system 102. In some embodiments, the promoted contents 114 presented to a user during use of the interactive software application may be changed based on current products, services, events, etc. Obtaining promoted content 114 from a promoted content server 112 may conserve computational and/or storage resources on the client device 106 or other device executing the content management system 102. In some embodiments, such as a client device with limited network connectivity, the content management system, the interactive software application 104, promoted contents 114, or combinations thereof are stored and executed locally on the client device 106.

As described herein, the content management system 102 presents promoted content 114 to the user during use of the interactive software application 104 based at least partially on contextual cues from or based on the interactive software application 104. In some embodiments, the content management system 102 is optionally in communication with an event detection module 116 that detects one or more events in the interactive software application 104 to provide a context-based promoted hint or trigger event. For example, the event detection module 116 may detect a save screen or dialog box and provide an indication to the content management system 102 of an opportunity to present promoted content. In another example, the event detection module 116 may detect a round end screen or dialog box and provide an indication to the content management system 102 of an opportunity to present promoted content. In another example, the event detection module 116 may detect a pause screen or dialog box and provide an indication to the content management system 102 of an opportunity to present promoted content.

As described herein, the event detection module 116 may be local to or remote from the content management system 102. For example, the event detection module 116 and content management system 102 may be on the client device 106 local to the user. In another example, the content management system 102 and event detection module 116 could be on streaming server that transmits to a client device 106 local to the user.

Promoted content (e.g., video promoted content, audio promoted content, static image promoted content, multimedia promoted content) is presented to the user, according to the present disclosure, periodically during use of the interactive software application. In some embodiments, the timing of the presentation of the promoted content is based on a credit duration. As described herein, the credit duration may be a time duration or based on progression or completion of tasks in the interactive software application. However, presentation of the promoted content based upon a time period only can produce a negative use experience.

FIG. 2 is a timeline of promoted content presentation and interactive software application usage. In some embodiments, a system presents promoted content 218 to a user (such as via a display of a client device) and the system establishes a credit 220 upon completion of the promoted content 218. In some embodiments, establishing a credit 220 includes incrementing a credit counter by 1, setting the credit counter to 1, or otherwise assigning an additional credit 220 to an account associated with the user. The system then grants access to the interactive software application usage 222 for a credit duration 224. Upon expiration of the credit duration 224 (e.g., the user has zero credits 220 available), the interactive software application usage 222 is interrupted and another promoted content 218 is presented to the user. The system then, in some embodiments, establishes another credit 220, and the system commences the interactive software application usage 222 for another credit duration 224. In some embodiments, the credit 220 allows the user or user account to rent, decrypt, gain access to, or otherwise enable or commence user inputs and interaction with the interactive software application. In some examples, the credit provides a predetermined credit duration in the interactive software application. In some examples, the credit is a duration of usage of the interactive software application. In at least one example, the credit is a 30-minute credit duration for 30 minutes of usage of a video game software application. In some examples, the credit duration is determined based at least partially on a mode or time of usage of the interactive software application. In a particular example, a single credit may provide 1 hour of usage of the interactive software application for a practice mode or a tutorial mode, while that same credit provides 30 minutes of single-player campaign mode in a video game or 20 minutes of online-multiplayer mode(s) in the same video game. In another example, one credit provides 1 hour of usage during a weekday afternoon, while the same credit provides 30 minutes of usage on a weekend evening.

In some instances, however, constraining, interrupting, suspending user inputs to, or otherwise preventing usage of the interactive software application independent of context can cause negative user experiences. For example, many online-based multiplayer video games (and some single-player video games) cannot be paused or suspended as the virtual environment of the game persists while the user is unable to interact with the interactive software application. This can result in the user losing an online multiplayer match, dying in a single-player role-playing game, being unable to communicate with or interact with teammates, or otherwise having a negative user experience. In some embodiments according to the present disclosure, promoted content 218 is presented to the user (and the interactive software application usage 222 interrupted) based at least partially on context from the interactive software application, ensuring the promoted content 218 is presented without substantially negatively impacting the user's experience in the interactive software application.

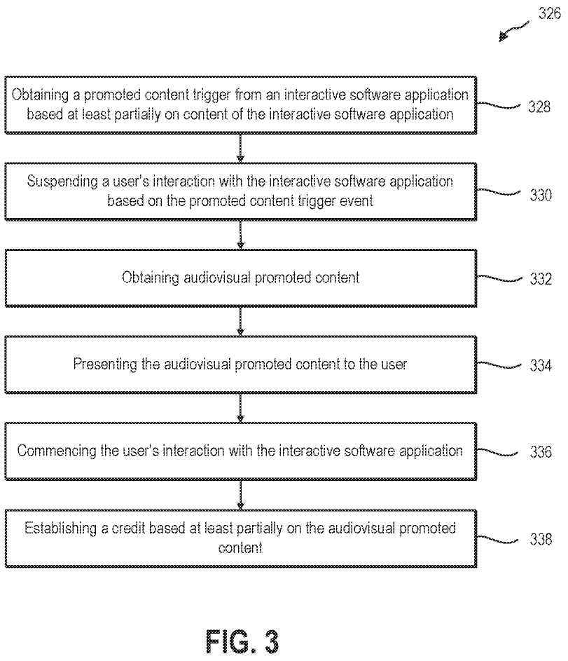

FIG. 3 is a flowchart illustrating an embodiment of a method 326 of providing promoted content to a user. In some embodiments, the method 326 is performed at least partially by a content management system of a client device. For example, the content management system may run natively on a user's personal computer or video game console. In some embodiments, the method 326 is performed at least partially by a content management system of a server computer. For example, the content management system may run on the same device executing the interactive software application. In other examples, the content management system may run on a different device than that executing the interactive software application. The method 326 includes obtaining a promoted content trigger event from an interactive software application based at least partially on content of the interactive software application at 328.

The method 326 further includes suspending a user's interaction with the interactive software application based on the promoted content trigger event at 330. In some embodiments, suspending the user's interaction with the interactive software application includes pausing the interactive software application. In some examples, the interactive software application continues running with a pause screen or dialog box active. In some embodiments, suspending the user's interaction with the interactive software application includes constraining or suspending the interactive software application. For example, constraining or suspending the interactive software application may temporarily stop execution of the interactive software application while retaining the application in memory, allowing the rapid resuming of the interactive software application at a later time. For example, many computing devices and/or video game consoles constrain or suspend an interactive software application when displaying a home screen or other software application while the user had been interacting with the interactive software application. In some embodiments, suspending or constraining the user's interaction with the interactive software application includes limiting and/or preventing user inputs from being transmitted to or received by the interactive software application. For example, when promoted content is presented during a loading screen, a round end screen, a title screen, a save screen, etc., the interactive software application may remain active and continue running “behind” the promoted content presentation. Because a running interactive software application may allow for potential effects to the user's avatar or in the virtual environment, contextually-aware presentations of the promoted content is even more important.

In some embodiments, the method 326 includes obtaining promoted audiovisual content at 332 and presenting the promoted audiovisual content at 334. In some embodiments, obtaining the promoted audiovisual content includes accessing or receiving the promoted audiovisual content from a remote server or storage device (e.g., promoted content server 112 described in relation to FIG. 1). In some embodiments, obtaining the promoted audiovisual content includes accessing the promoted audiovisual content from a local hardware storage device (e.g., hardware storage device 110 of the client device 106 described in relation to FIG. 1).

The method 326 further includes commencing the user's interaction with the interactive software application at 336 and establishing a credit at least partially based on the promoted audiovisual content at 338. In some embodiments, commencing the user's interaction with the interactive software application includes unpausing the interactive software application. In some embodiments, commencing the user's interaction with the interactive software application includes deconstraining the interactive software application. In some embodiments, commencing the user's interaction with the interactive software application includes unsuspending the interactive software application. In some embodiments, commencing the user's interaction with the interactive software application includes resuming transmitting user inputs to the interactive software application.

For example, the system may commence the user's interaction with the interactive software application after completion of the promoted content. In other examples, the system may commence the commencing the user's interaction with the interactive software application after establishing the credit at 338. In some examples, the user may opt to view another promoted content to earn additional credits. In at least some examples, the method includes providing suggestions or notifications to the user that additional promoted content is recommended or not recommended at that time. For example, the promoted content trigger event may indicate a promoted content opportunity duration during which the promoted content may be presented to the user without significantly adversely impacting the user experience. In at least one example, the promoted content trigger event may indicate a promoted content opportunity duration of 45 seconds. In some examples, the promoted content opportunity duration may correlate to a loading time for the interactive software application, after which the gameplay in a video game software application continues, and additional promoted content may be discouraged after the promoted content opportunity duration and during gameplay. In some embodiments, the promoted content trigger event may indicate a promoted content opportunity duration, while in some embodiments, the promoted content opportunity duration may be open-ended, and a second trigger event may terminate the promoted content opportunity duration. For example, the user may be invited to view additional promoted content until an

API call or an event detection module, as will described in more detail herein, identifies an end to the promoted content opportunity duration. In some embodiments, the method includes commencing the user's interaction with the interactive software application to allow the user to begin interacting with the interactive software application before establishing the credit at 338.

The method 326 can obtain the promoted content trigger event in a variety of manners in order to limit and/or prevent negative impact on the user experience. For example, the promoted content trigger event may be an API hint promoted content trigger event where a hint is obtained from an API of or in communication with the interactive software application provides a hint established by a developer of the interactive software application. A hint may be an indicator to the content management system that a point in the interactive software application is appropriate or preferred for an interruption and/or presentation of promoted content. For example, a narrative-driven interactive software application may include API hints at ends of chapters of the narrative. In some examples, an API hint may be received at or near the end of a credit duration, and the content management system interprets the hint as a trigger event.

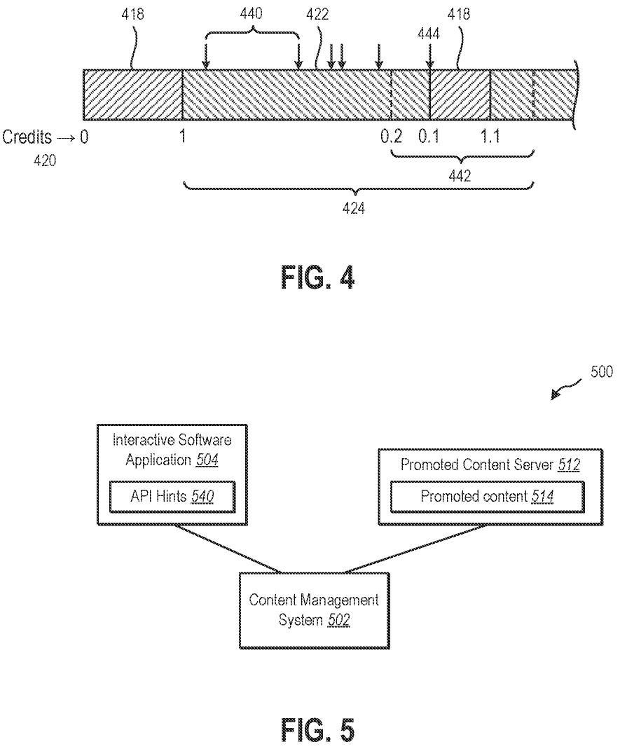

FIG. 4 is a timeline of an embodiment of promoted content presentation and interactive software application usage using API hints. In some embodiments, a system presents promoted content 418 to a user (such as via a display of a client device) and the system establishes a credit 420 upon completion of the promoted content 418. In some embodiments, establishing a credit 420 includes incrementing a credit counter by 1, setting the credit counter to 1, or otherwise assigning an additional credit 420 to an account associated with the user. The system grants access to the interactive software application usage 422 for a credit duration 424.

During the interactive software application usage 422, the interactive software application transmits or provides API hints 440. In some embodiments, the interactive software application calls the API to transmit or provide the API hints 440. During the interactive software application usage 422, the system may ignore the API hints 440. Approaching the end of the credit duration 424, an API hint 440 received by the system may be interpreted by the system as a promoted content trigger event and tell the system that the developer has indicated that the point in the interactive software application is appropriate to suspend the user's interaction and present promoted content 418 to the user.

In some embodiments, the system provides a window 442 near the end of the credit duration 424 during which the system can suspend the user's interaction and present promoted content 418 to the user. In some embodiments, prior to the window 442 during the interactive software application usage 422 of the credit duration 424, the system will not suspend the user's interaction and present promoted content 418 to the user. During the window 442, an API hint 440 received is interpreted as a promoted content trigger event 444 and the system suspends the user's interaction and presents promoted content 418 to the user.

In some embodiments, the window 442 is based on the credit duration 424. In some embodiments, the window 442 is proportionate to the credit duration 424. For example, the window 442 may be the last 20% of the credit duration 424. In another examples, the window 442 may be the last 10% of the credit duration 424. In some embodiments, the window 442 is the last 5 minutes of the credit duration 424. In some embodiments, the window 442 is the last 2 minutes of the credit duration 424. In some embodiments, the window 442 has a first window duration (e.g., 2 minutes) of the credit duration 424 when the credit duration 424 is less than a threshold value, such as 20 minutes, and the window 442 has a second window duration (e.g., 5 minutes) of the credit duration 424 when the credit duration 424 is greater than the threshold value.

In some embodiments, the credit balance is updated after the promoted content 418 is presented. For example, the credit balance may be restored to 1 credit after the promoted content 418 is presented. In the illustrated example, the promoted content trigger event 444 occurs with 0.1 credits remaining, and the credit 420 is added to the 0.1 credits after the promoted content 418 is presented. The user then commences interaction with the interactive software application with a credit balance of 1.1 credits, allowing a longer duration interactive software application usage 422 before the next window 442 and/or promoted content 418.

FIG. 5 is a system diagram of a system 500 for providing content to a user. As described in relation to FIG. 1, the system 500 includes a content management system 502 that is in data communication with an interactive software application 504. In some embodiments, the interactive software application 504 transmits or provides one or more API hints 540 to the content management system 502. The content management system 502 receives or recognizes the API hints 540 and interprets at least one as a promoted content trigger event.

In some embodiments, the content management system 502 manages the presentation of promoted audiovisual information obtained from a promoted content server 512. In some embodiments, the promoted contents 514 presented to a user during use of the interactive software application may be changed based on current products, services, events, etc. Obtaining promoted content 514 from a promoted content server 512 may conserve computational and/or storage resources on the device executing the content management system 502.

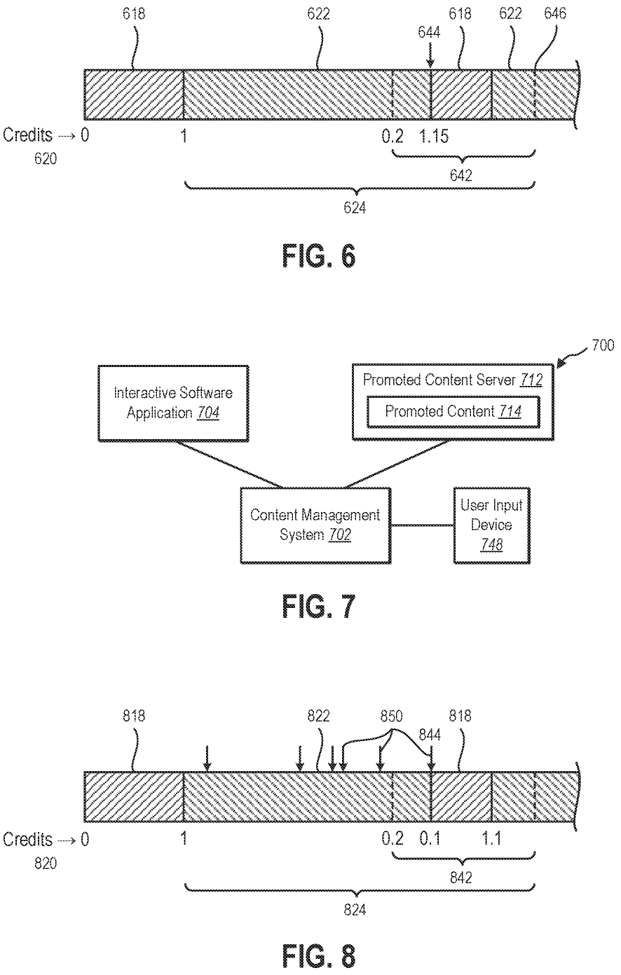

In some examples, an older interactive software application may not include API hints 540 than can be used to provide context awareness for the content management system 502. In some embodiments the content management system can receive user inputs from a user interacting with the interactive software application to interpret the content of the interactive software application and provide the context awareness. For example, FIG. 6 is a timeline illustrating an embodiment of providing promoted information to a user by a user-initiated promoted content trigger event. In some embodiments, a system presents promoted content 618 to a user (such as via a display of a client device) and the system establishes a credit 620 upon completion of the promoted content 618. In some embodiments, establishing a credit 620 includes incrementing a credit counter by 1, setting the credit counter to 1, or otherwise assigning an additional credit 620 to an account associated with the user. The system grants access to the interactive software application usage 622 for a credit duration 624.

In some embodiments, the system provides a window 642 near the end of the credit duration 624 during which the system can suspend the user's interaction and present promoted content 618 to the user. In some embodiments, prior to the window 642 during the interactive software application usage 622 of the credit duration 624, the system will not suspend the user's interaction and present promoted content 618 to the user. During the window 642, a notification is provided to the user indicating that promoted content 618 is available. The notification may be a visual (e.g., on-screen) notification. The notification may be an audio notification. In some embodiments, the notification includes information related to remaining credit duration and/or remaining window duration. For example, the notification may be a countdown time that indicates the remaining time in the credit duration. In another example, the notification may be a countdown time that indicates the remaining time in the window before the promoted content interrupts the user's interaction. In some embodiments, the user may provide a user input to the content management system in response to the notification, which is interpreted as a promoted content trigger event 644 and the system suspends the user's interaction and presents promoted content 618 to the user. The user input allows the user to select a time or situation with the interactive software application that the user would prefer the promoted content 618 be presented. This agency may allow the user to feel more confident with the timing and placement of the promoted content 618 during their interactive software application usage 622.

In some embodiments, the window 642 is based on the credit duration 624. In some embodiments, the window 642 is proportionate to the credit duration 624. For example, the window 642 may be the last 20% of the credit duration 624. In another examples, the window 642 may be the last 10% of the credit duration 624. In some embodiments, the window 642 is the last 5 minutes of the credit duration 624. In some embodiments, the window 642 is the last 2 minutes of the credit duration 624. In some embodiments, the window 642 has a first window duration (e.g., 2 minutes) of the credit duration 624 when the credit duration 624 is less than a threshold value, such as 20 minutes, and the window 642 has a second window duration (e.g., 5 minutes) of the credit duration 624 when the credit duration 624 is greater than the threshold value. At the end 646 of the credit duration 624, if no user input is received by the content management system, promoted content 618 is presented.

In some embodiments, the user input for the promoted content trigger event 644 is receivable at any time during the credit duration 624, and the user may earn credits 620 at any time. In some embodiments, the user input for the promoted content trigger event 644 is receivable at any time during the credit duration 624, and the notification is only presented during the window 642.

In some embodiments, the credit balance is updated after the promoted content 618 is presented. For example, the credit balance may be restored to 1 credit after the promoted content 618 is presented. In the illustrated example, the promoted content trigger event 644 occurs with 0.15 credits remaining, and the credit 620 is added to the 0.15 credits after the promoted content 618 is presented. The user then commences interaction with the interactive software application with a credit balance of 1.15 credits, allowing a longer duration interactive software application usage 622 before the next window 642 and/or promoted content 618.

FIG. 7 illustrates a system 700 for providing content to a user based at least partially on user inputs for the promoted content trigger event. As described in relation to FIG. 1, the system 700 includes a content management system 702 that is in data communication with an interactive software application 704. In some embodiments, a user input device 748 transmits one or more user inputs to the content management system 702. The content management system 702 receives or recognizes the user input and interprets the user input as a promoted content trigger event.

In some embodiments, the content management system 702 manages the presentation of promoted audiovisual information obtained from a promoted content server 712. In some embodiments, the promoted contents 714 presented to a user during use of the interactive software application may be changed based on current products, services, events, etc. Obtaining promoted content 714 from a promoted content server 712 may conserve computational and/or storage resources on the device executing the content management system 702.

In some instances, a user may not know what events, environments, or actions are coming in the interactive software application, and the user may not easily determine when to initiate a promoted content trigger event through a user input. In some embodiments, an event detection model, system, or module may communicate with the content management system to provide hints and/or promoted content trigger events. For example, FIG. 8 is a timeline illustrating an embodiment of providing promoted information to a user using event hints. In some embodiments, a system presents promoted content 818 to a user (such as via a display of a client device) and the system establishes a credit 820 upon completion of the promoted content 818. In some embodiments, establishing a credit 820 includes incrementing a credit counter by 1, setting the credit counter to 1, or otherwise assigning an additional credit 820 to an account associated with the user. The system grants access to the interactive software application usage 822 for a credit duration 824.

During the interactive software application usage 822, the event detection module transmits or provides event hints 850. During the interactive software application usage 822, the system may ignore the event hints 850. Approaching the end of the credit duration 824, an event hint 850 received by the system may be interpreted by the system as a promoted content trigger event and tell the system that an event in the interactive software has been detected that indicates an appropriate time in the interactive software application to suspend the user's interaction and present promoted content 818 to the user.

In some embodiments, the system provides a window 842 near the end of the credit duration 824 during which the system can suspend the user's interaction and present promoted content 818 to the user. In some embodiments, prior to the window 842 during the interactive software application usage 822 of the credit duration 824, the system will not suspend the user's interaction and present promoted content 818 to the user. During the window 842, an event hint 850 received is interpreted as a promoted content trigger event 844 and the system suspends the user's interaction and presents promoted content 818 to the user.

In some embodiments, the window 842 is based on the credit duration 824. In some embodiments, the window 842 is proportionate to the credit duration 824. For example, the window 842 may be the last 20% of the credit duration 824. In another examples, the window 842 may be the last 10% of the credit duration 824. In some embodiments, the window 842 is the last 5 minutes of the credit duration 824. In some embodiments, the window 842 is the last 2 minutes of the credit duration 824. In some embodiments, the window 842 has a first window duration (e.g., 2 minutes) of the credit duration 824 when the credit duration 824 is less than a threshold value, such as 20 minutes, and the window 842 has a second window duration (e.g., 5 minutes) of the credit duration 824 when the credit duration 824 is greater than the threshold value. At the end 846 of the credit duration 824, if no user input is received by the content management system, promoted content 818 is presented.

In some embodiments, the credit balance is updated after the promoted content 818 is presented. For example, the credit balance may be restored to 1 credit after the promoted content 818 is presented. In the illustrated example, the promoted content trigger event 844 occurs with 0.1 credits remaining, and the credit 820 is added to the 0.1 credits after the promoted content 818 is presented. The user then commences interaction with the interactive software application with a credit balance of 1.1 credits, allowing a longer duration interactive software application usage 822 before the next window 842 and/or promoted content 818.

An event detection model, system, or module, in some embodiments, includes a machine learning model or system to detect and identify events in the video information, audio information, game state data, or other information provided by or from the interactive software application to the event detection module and/or content management system, such as described in relation to FIG. 1. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to a ML system to use in generating an output, such as events within video information from the interactive software application provided to the event detection module and/or the content management system. For example, an instance may refer to any virtual object provided in the user interface (UI) of the video information. For example, a UI may present notifications to a user in response to certain game events. The ML system may perform one or more machine vision techniques to evaluate the video information for associated events when the UI notification is present. The ML system may refine over iterations to “learn” when visual game events are correlated with the UI notification. For example, a UI element indicating player avatar health may increase in value in response to the player avatar interacting with a health pack in the game environment.

In some embodiments, the ML system can create an application module of expected or correlated game events in the video information. In a particular example, if the UI element indicates that the playing user has performed an opponent elimination, other aspects of the video information may be detected and/or identified to associate opponent eliminations with the identified animation. In another example, each time a player avatar performs an assist, the ML system may identify to whom the player avatar passed the ball for the goal (such as in sports games). Further, the ML system can create or refine an application module to include commonly queried or associated categories of tags for events. In some examples, all key events may be associated a with a match timestamp, while opponent eliminations, specifically, further include tags indicating what weapon the player avatar had equipped at that time. In some embodiments, the key events or other events may signal transition points in the gameplay that may be hints or otherwise interpreted at promoted content trigger events. In some embodiments, the key events or other events may signal exciting, interesting, or competitive points in the gameplay that may provide context to the content management system to not interrupt the interactive software application, as the user's experience is particularly intense at that point in time.

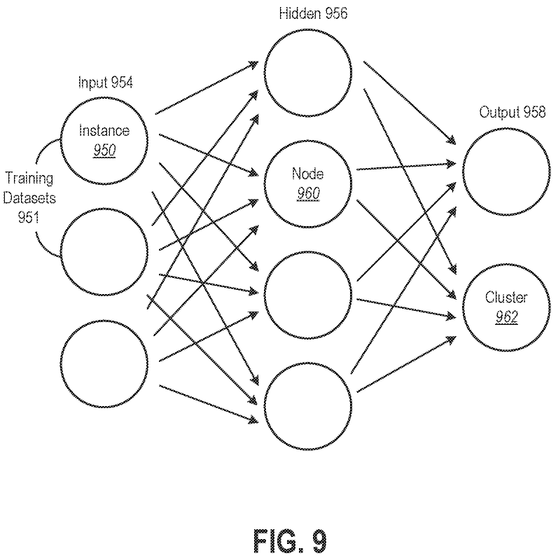

FIG. 9 is a schematic illustration of a ML model. In some embodiments, the machine learning system has a plurality of layers with an input layer 954 configured to receive at least one input training dataset 951 or input training instance 952 and an output layer 958, with a plurality of additional or hidden layers 956 therebetween. The training datasets can be input into the machine learning system to train the machine learning system and identify individual and combinations of labels or attributes of the training instances. In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers 956 between the input layer 954 and the output layer 958. The hidden layers 956 have a plurality of input nodes (e.g., nodes 960), where each of the nodes operates on the received inputs from the previous layer. In a specific example, a first hidden layer 956 has a plurality of nodes and each of the nodes performs an operation on each instance from the input layer 954. Each node of the first hidden layer 956 provides a new input into each node of the second hidden layer, which, in turn, performs a new operation on each of those inputs. The nodes of the second hidden layer then passes outputs, such as identified clusters 962, to the output layer 958.

In some embodiments, each of the nodes 960 has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

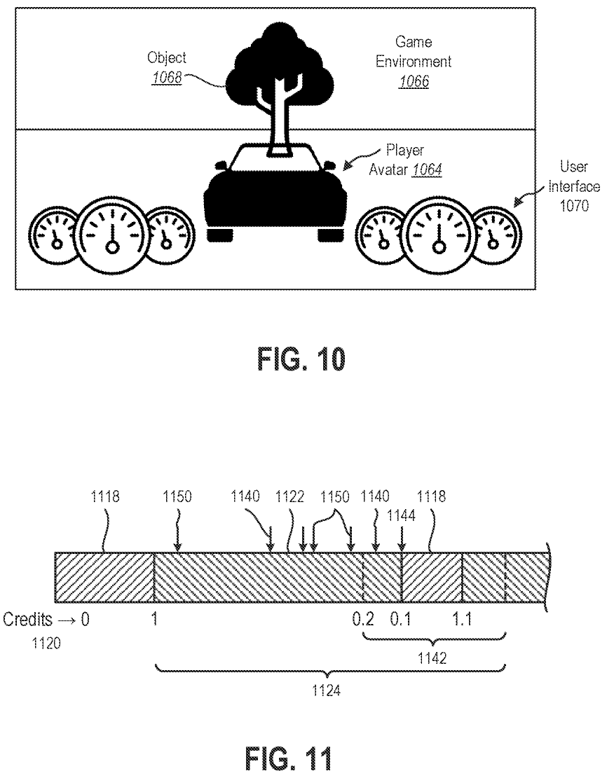

FIG. 10 is an embodiment of a frame of video information received from the interactive software application that may be used for identifying events within the user's gameplay. In FIG. 10, a frame of video information includes an object 1068 (e.g., a tree) positioned in the game environment 1066 with the player avatar 1064, in this case a car. Other objects in the frame include the user interface 226 which may be independent of the three-dimensional game environment 1066. The machine vision may identify the position, size, and shape of the tree object 1068 relative to the player avatar 1064 to determine relative position of the object 1068 and the avatar 1064 in the game environment 1066. By evaluating the relative position of the object 1068 and the avatar 1064 in one frame or a sequence of frames (adjacent frames at the native framerate or non-adjacent key frames), the machine vision and/or ML system may identify a crash between the car and the tree. The crash may be identified as a key event and denoted as such relative to the social media metrics.

In some embodiments, the video information of the interactive software application provided by the device running the game application is associated with game state data. Game state data includes any information that may allow a second electronic device to recreate a given game state. For example, the game state data of a game instance running on a client device may be provided to a second electronic device, which may render a duplicate of the first game instance based on the game state data. In some embodiments, game state data includes virtual object or avatar positions, movement, player character statistics or characteristics, player character inventory, player character status, ability cooldown status, non-player character status, or any other information about the game state.

Because the video information can be associated with the game state data, object identifications (IDs) may be associated with the objects detected in the video information, allowing higher reliability in the object detection. Additionally, the game state data may include object IDs, which can be compared to the detected objects to refine a ML system of the machine vision and improve the object detection of the system.

In some embodiments, machine vision and/or object detection can measure relative motion of edges to determine the position of virtual objects. For example, a detected object that does not change position within the frames across a plurality of frames of the video information while the avatar moves and/or the user's perspective relative to the game environment moves may be an element of the UI 1070. In other examples, a detected object that increases in size differently than the other objects in the game environment may be moving relative to the game environment. In the illustrated embodiment in FIG. 10, a crash key event may be identified by a change in the UI 1070 depicting the speedometer rapidly and/or suddenly decreasing in value. For example, a rapid change in the UI 1070 reflecting a change in speed of the car avatar 1064 from 150 kilometers per hour (kph) to 0 kph in under 1.0 seconds may be identified as a crash.

A virtual object, as used herein, may include any object or element rendered or presented by the client device in the process of running the game application. For example, a virtual object may be an element of the UI 1070. In some examples, a virtual object may be a player avatar 1064. In some examples, the virtual object may be wall, floor, or other geometry of the game environment 1066 such as a tree object 1068. In some examples, the virtual object may be an interactive or movable object within the game environment, such as a door, crate, or power-up.

In some embodiments, the machine vision and/or ML model can identify objects in the game environment 1066 without explicit training to identify the object. For example, a machine vision system that includes ML may learn to identify tree objects 1068 within the game environment 1066, even if the particular model of tree object 1068 has not been explicitly taught to the machine vision system. In at least one example, systems and methods according to the present disclosure may be portable between video information from a variety of game applications where different models for common objects, such as the tree object 1068, are used. By training the ML model, the machine vision may be able to recognize and detect a tree object 1068 in the video information. In some examples, elements of the game environment are procedurally generated. A series of procedurally generated tree objects 1068 may include common elements but be distinct models from one another, as rendered in the video information. Therefore, an explicitly provided model would be inapplicable to procedurally generated tree objects 1068.

In some embodiments, the machine vision system invokes an application module that is associated with the game application that is the source of the video information. Art styles can vary considerably between game applications. Even a ML model that has been trained on video information from a plurality of game applications to detect tree objects 1068 may fail when presented with a new art style. For example, while both FORNITE and CALL OF DUTY are competitive first-person shooter games, the appearance of objects is very different between the games. Specifically, tree objects 1068 and other elements of the game environment 1066 appear very different between the two game applications.

Systems and methods according to the present disclosure may access an application module that is associated with the game application that is the source of the video information. The application module may be generated by the ML model based on the game engine, may include predetermined or user-defined events, or combinations of both.

As described herein, the ML model data may be stored remotely to the client device and/or the server computer and be accessed by the server computer as needed based on the video information or other information provided by the client device. In at least one embodiment, the ML model data is part of an application module including game application-specific information for machine vision and/or event identification and classification.

The ML model may allow for identification of objects and/or events with tags associated therewith. The object detection may include any of the methods or techniques described herein to identify the virtual objects in the video information. In some embodiments, the method includes determining the presence of a key event, a popular event, a rare event, or any other type of event based on the present of the object, texture, model, or animation. In some embodiments, determining the presence of an event includes evaluating a change in the virtual object, texture, model, or animation between frames of the plurality of frames. In some embodiments, compared frames are adjacent frames in the native framerate of the rendered game environment. For example, the video information may include 60 frames per second as the client device renders the game environment at 60 frames per second. The compared frames may be adjacent frames in the native 60 frames per second with a delta of approximately 16.67 milliseconds between frames. In some embodiments, the compared frames are key frames or other non-adjacent frames in the native framerate. For example, the video information may include 60 frames per second as the client device renders the game environment at 60 frames per second, but the compared frames are selected 0.25 seconds apart from one another or approximately 15 frames apart.

The changes to the virtual object between the first frame and the second frame may be calculated based on changes relative to the game environment, or changes based on expected correlations. Some changes in the virtual object relative to the game environment may include the appearance or disappearance of the virtual object in the game environment. The comparison of frames may include the detection of a particular animation of an avatar model or other model. A comparison of frames may include the detection of change in textures skinning a model, which may be associated with an event such as receiving damage or acquiring a new piece of equipment in the game.

In some embodiments, determining the presence of an event in the video information includes comparing the detected object, texture, model, or animation to one or more events of an application module. The application module may be predetermined or may be generated by an ML system. In some embodiments, the application module includes key events, popular events, rare events, any other types of events, or combinations thereof.

In at least one embodiment, key events are events that progress a gameplay session toward a resolution or definitive outcome. Such key events may be uses event hints and/or promoted content trigger events, such as described in relation to FIG. 8. In some embodiments, key events may be predetermined in the application module specifically for the game application being played. Key events for an American football game application may include a touchdown, field goal, fumble, fumble recovery, sack, interception, punt, kickoff, halftime, or full time. Key events for a first-person shooter (FPS) game application may include an opponent elimination, a player elimination, a health pickup, a shield pickup, a reload, a multi-elimination, a round victory, a teammate elimination, a flag pickup, or a point capture. Key events for a MOBA game application may include an opponent elimination, a player elimination, a health pickup, a shield pickup, an ability usage, a cooldown expiration, a multi-elimination, a round victory, a teammate elimination, player-versus-environment (PvE) elimination; or a player avatar respawn (as the respawn may be delayed from the elimination). The application module can include information regarding key events that may be used to detect and identify commonly referenced events in the course of a gameplay session for later review. In some embodiments, key events may occur at times when an interruption in the interactive software application usage is inconvenient, and user-confirmation of the events for consideration as a promoted content trigger event is described in more detail below.

In some embodiments, the application module includes additional event identification based on popular events. A popular event may be a point of excitement and/or curiosity to a user, and a popular event may indicate to the content management system to not interrupt the interactive software application usage while the user is engaged. For example, some game applications develop a particular set of popular events that viewers and players recognize for skill, strategy, or spectator excitement that may not be considered key events within the course of play. In at least one example, popular events need not advance the game toward a particular outcome, but rather hold a unique interest within a viewership of a game application. For example, in a baseball game application, a batter advancing from home plate to first base progresses the game toward a resolution. In some embodiments, a machine vision and/or ML system according to the present disclosure may detect and identify a difference between a batter advancing by hitting a single, being walked on balls, or being struck by a pitch.

A popular event may be independent of a key event. In some embodiments, shattering a board in a hockey game application has no effect on the outcome of the game, but may hold a unique interests to players and spectators. A popular event may be identified in addition to a key event. In some embodiments, a machine vision and/or ML system may identify a flyout as a key event, while identifying a flyout that is caught by the outfielder jumping above the home run fence as a popular event of unique interest. A popular event may be a combination of key events in sequence or proximity. In some embodiments, a super attack in a fighting game is a key event, and a reversal is a key event, but a player reversing a super attack, specifically, is identified as a popular event. In some embodiments, an event that occurs within a particular amount of time (temporal proximity) of another event, such as a series of opponent eliminations, is identified as a popular event.

In some embodiments, the application module includes exploits in the game, such as known bugs, which are allowed in certain areas of competitive electronic gaming. For example, collision bugs between the player avatar and objects in the game environment may be exploited to enable traversal techniques that are otherwise impossible in the game engine. In some communities of speedrunning electronic games, the use of exploits, while not the intended manner of operation of the game engine, are allowed or encouraged. Such exploit events may be considered popular events, as they are not necessary for the completion of the game, but rather are uniquely interesting usages of or interactions with the game environment for a particular demographic of viewership.

In some embodiments, textures, models, animations, or sequences of key events or other occurrences in video information depicting a game environment may not be present or identifiable under an existing application module or event list. Such occurrences may be identified as rare events. In some embodiments, rare events include some bugs or exploits that are not intended in the game environment. In some embodiments, rare events include secrets or hidden features that are uncommonly experienced in the game. For example, a hidden character or stage in a game application may require elaborate conditions to be met before a player will activate the character. As such, rare events may be experienced by a limited number of players. A rare event may be a point of excitement and/or curiosity to a user, and a rare event may indicate to the content management system to not interrupt the interactive software application usage while the user is engaged. Experience of rare events may be associated with a specific type of player interested in exploring the details of the game environment or game application, and tags associated with rare events can assist in providing relevant information in the user profile.

In some embodiments, the application module includes probability tables that allow the detection of rare events in the video information. For example, drop tables for a role-playing game may control the probability that a game engine provides a particular item to the player avatar in the game environment. If an item has a drop rate of 5.0%, a single detection of the item in the video information is, while uncommon by design, non-anomalous. However, if the method or system described herein detects the item dropping 5 out of 20 chances (a 0.000000147% chance), the sequence may indicate a rare event of interest. In another example, running an identical play in an American football simulation game application multiple times consecutively with the same results may be improbable. While selecting the same play multiple times in a row may not be uncommon or improbable, running the same play with the same result (such as a weak side sweep run play to the sideline that produces 7 yards every play for 11 consecutive plays) may indicate rare event of interest. The application module may include threshold values to determine when a series of probable events becomes sufficiently rare to be designated a rare event. In some embodiments, a probability curve may be calculated based on the drop table or other probability table, and a threshold may be set at a standard deviation away from a most likely outcome. In another embodiment, the threshold may be set manually, such that a detected rare event or sequence of events is reported when the occurrence exceeds the manually set threshold.

While some embodiments of systems and methods for identifying and/or tagging events a user evaluate only video information, some embodiments evaluate other forms of information or data to supplement the video information. In some embodiments, the gameplay obtained further includes audio information. Audio information can provide additional data regarding events in the game environment that may not be visible on the video information. In some embodiments, audio cues such as dialog, music, or sound effects may indicate the presence, proximity, or direction of objects or events in the game environment. In some examples, a player avatar may hide from an attack made by a boss character, preventing visual identification of the boss character or the attack, while the audio cue indicates the occurrence of the off-screen attack. In some embodiments, the audio information includes player or chat commentary from the recording of the video information and audio information, allowing identification of discussion or comments about the game environment.

In some embodiments, the video information includes user input information. A user input, according to the present disclosure, should be understood to include any signal or input by any input mechanism that provides instructions to the client device to interact with and/or affect the game application. The user input information may provide additional context to the detected events in the evaluated frames of the video information. For example, the user input may indicate that a user was attempting to input a super attack command in a fighting game, which was anticipated and reversed, producing an example of a combined key event, popular event, and a rare event.

In some examples, the event detection module and/or the content management system may detect events but may be unable to determine when to present promoted content to the user. In some embodiments, the content management system may receive hints (API hints and/or event hints) and provide notifications and/or prompts to the user. A user input may confirm the prompt based on the hints, and the user input confirming the prompt may be considered a promoted content trigger event. FIG. 11 is a timeline illustrating an embodiment of providing promoted information to a user by a user-confirmed promoted content trigger event. In some embodiments, a system presents promoted content 1118 to a user (such as via a display of a client device) and the system establishes a credit 1120 upon completion of the promoted content 1118. In some embodiments, establishing a credit 1120 includes incrementing a credit counter by 1, setting the credit counter to 1, or otherwise assigning an additional credit 1120 to an account associated with the user. The system grants access to the interactive software application usage 1122 for a credit duration 1124.

During the interactive software application usage 1122, the event detection module transmits or provides API hints 1140 and/or event hints 1150. During the interactive software application usage 1122, the system may ignore the API hints 1140 and/or event hints 1150. Approaching the end of the credit duration 1124, API hints 1140 and/or event hints 1150 received by the system may be considered by the system as a potential promoted content trigger event and tell the system that an event in the interactive software has been detected may indicates an appropriate time in the interactive software application to suspend the user's interaction and present promoted content 1118 to the user.

In some embodiments, the system provides a window 1142 near the end of the credit duration 1124 during which the system can suspend the user's interaction and present promoted content 1118 to the user. In some embodiments, prior to the window 1142 during the interactive software application usage 1122 of the credit duration 1124, the system will not suspend the user's interaction and present promoted content 1118 to the user. During the window 1142, API hints 1140 and/or event hints 1150 received are interpreted as a potential promoted content trigger event. The system may present a notification or prompt to the user based on the API hints 1140 and/or event hints 1150 and, upon confirmation via a user input, the system suspends the user's interaction and presents promoted content 1118 to the user. In some embodiments, the confirmation of the particular API hint 1140 and/or event hint 1150 may be further input into an ML model, such as described in relation to FIG. 9, as a training instance to further refine the ML model.

In some embodiments, the window 1142 is based on the credit duration 1124. In some embodiments, the window 1142 is proportionate to the credit duration 1124. For example, the window 1142 may be the last 20% of the credit duration 1124. In another examples, the window 1142 may be the last 10% of the credit duration 1124. In some embodiments, the window 1142 is the last 5 minutes of the credit duration 1124. In some embodiments, the window 1142 is the last 2 minutes of the credit duration 1124. In some embodiments, the window 1142 has a first window duration (e.g., 2 minutes) of the credit duration 1124 when the credit duration 1124 is less than a threshold value, such as 20 minutes, and the window 1142 has a second window duration (e.g., 5 minutes) of the credit duration 1124 when the credit duration 1124 is greater than the threshold value. At the end 1146 of the credit duration 1124, if no user input is received by the content management system, promoted content 1118 is presented.

In some embodiments, the credit balance is updated after the promoted content 1118 is presented. For example, the credit balance may be restored to 1 credit after the promoted content 1118 is presented. In the illustrated example, the promoted content trigger event 1144 occurs with 0.1 credits remaining, and the credit 1120 is added to the 0.1 credits after the promoted content 1118 is presented. The user then commences interaction with the interactive software application with a credit balance of 1.1 credits, allowing a longer duration interactive software application usage 1122 before the next window 1142 and/or promoted content 1118.

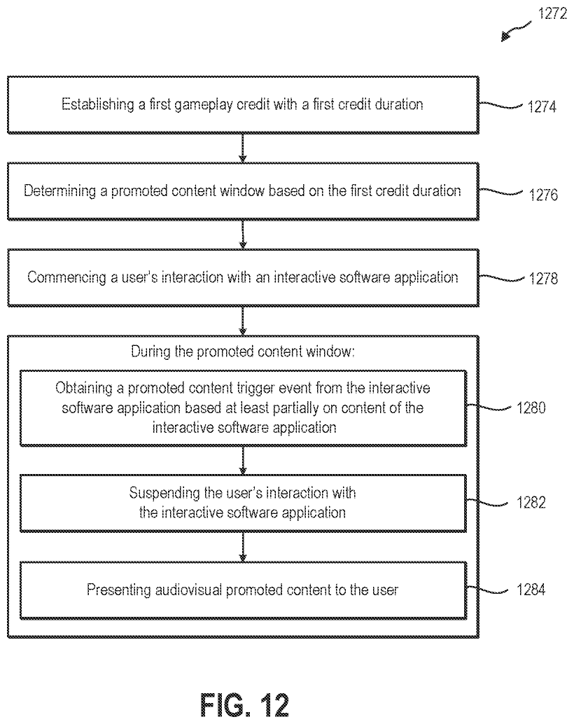

While embodiments of systems and methods described herein contemplate interrupting an interactive software application usage to present promoted content and establish a credit, in some embodiments, a first credit is established before commencing a user's interaction with the interactive software application. FIG. 12 is a flowchart illustrating an embodiment of a method 1272 of presenting content to a user. The method includes establishing a first credit with a first credit duration at 1274. In some embodiments, the first credit is stored and retrieved from a prior usage session. In some embodiments, the first credit is gifted to the user or user account. In some embodiments, the first credit is established after presentation of promoted content to a user. In some embodiments, the first credit is one of a plurality of credits.

The method 1272 further includes determining a window based on the first credit duration at 1276. As described herein, in some embodiments, the window is based on the credit duration. For example, the window may be the last 20% of the credit duration. In another examples, the window may be the last 10% of the credit duration. In some embodiments, the window is the last 5 minutes of the credit duration. In some embodiments, the window is the last 2 minutes of the credit duration. In some embodiments, the window has a first window duration (e.g., 2 minutes) of the credit duration when the credit duration is less than a threshold value, such as 20 minutes, and the window has a second window duration (e.g., 5 minutes) of the credit duration when the credit duration is greater than the threshold value.

The method 1272 includes commencing a user's interaction with an interactive software application at 1278, and during the window, obtaining a promoted content trigger event from the interactive software application based at least partially on the content of the interactive software application at 1280. The method 1272 can obtain the promoted content trigger event in a variety of manners in order to limit and/or prevent negative impact on the user experience. For example, the promoted content trigger event may be an API hint promoted content trigger event where a hint is obtained from an API of or in communication with the interactive software application provides a hint established by a developer of the interactive software application. A hint may be an indicator to the content management system that a point in the interactive software application is appropriate or preferred for an interruption and/or presentation of promoted content. For example, a narrative-driven interactive software application may include API hints at ends of chapters of the narrative. In some examples, an API hint may be received at or near the end of a credit duration, and the content management system interprets the hint as a trigger event. In some embodiments, obtaining the promoted content trigger event includes receiving a user input from a user input device as described herein. In some embodiments, obtaining the promoted content trigger event includes receiving an event hint from an event detection module as described herein. In some embodiments, obtaining the promoted content trigger event includes confirming a prompt with a user input, where the prompt is based on an API hint, an event hint, or other context-based cue. The method 1272 further includes suspending the user's interaction with the interactive software application at 1282 and presenting promoted audiovisual content to the user such as described in relation to FIG. 3.

In some embodiments, the method 1272 further includes establishing a second credit after presenting the promoted content, as described herein. In some embodiments, the second credit has a second credit duration that is the same as the first credit duration. In some embodiments, the second credit has a second credit duration that is different from the first credit duration. For example, the second credit duration may be greater than the first credit duration. In another example, the second credit duration is based at least partially on the content of the promoted content presented. For example, different promoted audiovisual content may support different credit durations. In other examples, the second credit duration is based at least partially on the length of the promoted content presented to the user.

In at least some embodiments, systems and methods described herein allow for a contextually-aware interruption of a user's interaction with an interactive software application for the presentation of promoted content. By interrupting the user's interaction with contextually appropriate, the user's experience may be improved.

The present disclosure relates to systems and methods for providing promoted contents to a user according to at least the examples provided in the sections below:
Section 1. A method of providing content to a user, the method comprising: obtaining a promoted content trigger event from an interactive software application based at least partially on content of the interactive software application; suspending a user's interaction with the interactive software application based on the promoted content trigger event; obtaining promoted audiovisual content; presenting the promoted audiovisual content to the user; commencing the user's interaction with the interactive software application; and establishing a credit based at least partially on the promoted audiovisual content, wherein the credit delays suspension of the user's interaction with the interactive software application during a credit duration.
Section 2. The method of section 1, wherein the promoted content trigger event is determined by an event detection module.
Section 3. The method of section 1, wherein the promoted content trigger event is an application programming interface (API) hint received via an API.
Section 4. The method of section 1, wherein the promoted content trigger event is a user input provided to the interactive software application by a user input device.
Section 5. The method of any of sections 1 through 4, further comprising a promoted content window, wherein the user's interaction is suspended in response to the promoted content trigger event when the promoted content trigger event is obtained during the promoted content window.
Section 6. The method of section 5, wherein the promoted content window is based at least partially on the credit duration.
Section 7. The method of section 6, wherein the promoted content window is proportionate to the credit duration.
Section 8. The method of any of sections 1 through 7, wherein the promoted content trigger event further includes a user input from a user input device.
Section 9. The method of section 8, further comprising providing the user input as a training input to a machine learning model configured to generate promoted content trigger events.
Section 10. The method of any of sections 1 through 9, wherein suspending the user's interaction with the interactive software application includes constraining or suspending the interactive software application.
Section 11. A method of providing content to a user, the method comprising: establishing a first credit with a first credit duration; determining a window based on the first credit duration; commencing a user's interaction with an interactive software application; during the window: obtaining a promoted content trigger event from the interactive software application based at least partially on content of the interactive software application; suspending the user's interaction with the interactive software application; and presenting promoted audiovisual content to the user.
Section 12. The method of section 11 further comprising establishing a second credit with a second credit duration based at least partially on the promoted audiovisual content.
Section 13. The method of section 12, wherein the second credit duration is based at least partially on a promoted content duration of the promoted audiovisual content.
Section 14. The method of section 12, wherein the second credit duration is based at least partially on content of the promoted audiovisual content.
Section 15. The method of any of sections 11 through 14 further comprising presenting a notification to a user prior to suspending the user's interaction.
Section 16. The method of section 15, wherein the notification is a countdown timer.
Section 17. The method of any of sections 11 through 16, wherein the first credit duration is defined at least partially based on progression through the interactive software application.
Section 18. A system comprising: a client device including: a processor, and a hardware storage device in data communication with the processor, wherein the hardware storage device has instructions stored thereon that, when executed by the processor, cause the client device to: obtain a promoted content trigger event from an interactive software application based at least partially on content of the interactive software application; suspend a user's interaction with the interactive software application based on the promoted content trigger event; obtain promoted audiovisual content; present the promoted audiovisual content to a user; commence the user's interaction with the interactive software application; and establish a credit based at least partially on the promoted audiovisual content, wherein the credit delays suspension of the user's interaction with the interactive software application during a credit duration.
Section 19. The system of section 18, wherein the interactive software application is executed on a remote device and at least video information from the interactive software application is transmitted to the client device.
Section 20. The system of section 18, wherein the client device is further in data communication with an event detection module, and the event detection module provides an event hint to the client device.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” sections are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method of providing content to a user, the method comprising:
establishing a promoted content window;
obtaining a promoted content trigger event from an interactive software application based at least partially on content of the interactive software application;
when the promoted content trigger event is obtained before the promoted content window, ignoring the promoted content trigger event;
when the promoted content trigger event is obtained during the promoted content window, suspending a user's interaction with the interactive software application based on the promoted content trigger event;
obtaining promoted audiovisual content;
presenting the promoted audiovisual content to the user;
commencing the user's interaction with the interactive software application; and
establishing a credit based at least partially on the promoted audiovisual content, wherein the credit delays suspension of the user's interaction with the interactive software application during a credit duration.

2. The method of claim 1, wherein the promoted content trigger event is determined by an event detection module.

3. The method of claim 1, wherein the promoted content trigger event is an application programming interface (API) hint received via an API.

4. The method of claim 1, wherein the promoted content trigger event is a user input provided to the interactive software application by a user input device.

5. (canceled)

6. The method of claim 5, wherein the promoted content window is based at least partially on the credit duration.

7. The method of claim 6, wherein the promoted content window is proportionate to the credit duration.

8. The method of claim 1, wherein the promoted content trigger event further includes a user input from a user input device.

9. The method of claim 8, further comprising providing the user input as a training input to a machine learning model configured to generate promoted content trigger events.

10. The method of claim 1, wherein suspending the user's interaction with the interactive software application includes constraining or suspending the interactive software application.

11. A method of providing content to a user, the method comprising:
establishing a first credit with a first credit duration;
determining a promoted content window based on the first credit duration;
commencing a user's interaction with an interactive software application;
during the promoted content window:
obtaining a promoted content trigger event from the interactive software application based at least partially on content of the interactive software application,
suspending the user's interaction with the interactive software application, and
presenting promoted audiovisual content to the user; and
before the promoted content window:
obtaining a promoted content trigger event from the interactive software application based at least partially on content of the interactive software application, and
ignoring the promoted content trigger event.

12. The method of claim 11 further comprising establishing a second credit with a second credit duration based at least partially on the promoted audiovisual content.

13. The method of claim 12, wherein the second credit duration is based at least partially on a promoted content duration of the promoted audiovisual content.

14. The method of claim 12, wherein the second credit duration is based at least partially on content of the promoted audiovisual content.

15. The method of claim 11 further comprising presenting a notification to a user prior to suspending the user's interaction.

16. The method of claim 15, wherein the notification is a countdown timer.

17. The method of claim 11, wherein the first credit duration is defined at least partially based on progression through the interactive software application.

18. A system comprising:
a client device including:
a processor, and
a hardware storage device in data communication with the processor, wherein the hardware storage device has instructions stored thereon that, when executed by the processor, cause the client device to:
obtain a promoted content trigger event from an interactive software application based at least partially on content of the interactive software application;
when the promoted content trigger event is obtained before the promoted content window, ignoring the promoted content trigger event;
when the promoted content trigger event is obtained during a promoted content window, suspend a user's interaction with the interactive software application based on the promoted content trigger event;
obtain promoted audiovisual content;
present the promoted audiovisual content to a user;
commence the user's interaction with the interactive software application; and
establish a credit based at least partially on the promoted audiovisual content, wherein the credit delays suspension of the user's interaction with the interactive software application during a credit duration.

19. The system of claim 18, wherein the interactive software application is executed on a remote device and at least video information from the interactive software application is transmitted to the client device.

20. The system of claim 18, wherein the client device is further in data communication with an event detection module, and the event detection module provides an event hint to the client device.

21. The method of claim 1, wherein the promoted content window has a promoted content opportunity duration, and based at least partially on the promoted content opportunity duration, offer an additional promoted audiovisual content to the user.
